(19) United States
(12) Patent Application Publication
(10) Pub. No.: US 2024/0401204 A1
(43) Pub. Date: Dec. 5, 2024

(54) METHOD AND COMPOSITION FOR ADJUSTING HYDROPHILICITY OF METAL USING A POLYPHENOL AND A SILANE MODIFIED NANO PARTICULATE OR AMINO ACID AMND SILICA

(71) Applicant: Bulk Chemicals, Reading, PA (US)

(72) Inventors: Jose B. Rivera, Auburn, PA (US); Hudson VanOrmer, Lancaster, PA (US); Cody R. Hanna, Lancaster, PA (US)

(73) Assignee: Bulk Chemicals, Reading, PA (US)

(21) Appl. No.: 18/731,903

(22) Filed: Jun. 3, 2024

Related U.S. Application Data
(60) Provisional application No. 63/471,062, filed on Jun. 5, 2023.

(51) Int. Cl. C23C 22/68

(52) U.S. Cl. CPC C23C 22/68

(57) ABSTRACT

A composition and method for creating hydrophilic surfaces is disclosed. The composition comprises a polyphenol and a hydrolyzed organosilane, such as organo-trisilanol, which is generated from an organosilane precursor such as hexamethyldisiloxane through hydrolysis and condensation reactions and reacting this with a nano particulate, an amino acid, silica, or a combination thereof. The composition can be applied by brushing, spraying, or dip-coating, and reacts with the surface to create a hydrophilic surface without the need for chemical or mechanical abrasion. The surface can be further treated with a rinse or wiping step to remove any excess composition. The resulting surface is hydrophilic, durable, and resistant to chemical and mechanical abrasion.

### RELATED APPLICATION

This application claims the benefit of priority to U.S. Provisional Patent Application Ser. No. 63/471,062, filed on Jun. 5, 2023, the contents of which are incorporated in this application by reference.

### TECHNICAL FIELD

The present invention relates to a composition and method for adjusting the hydrophilicity of a metal using a pholyphenol and a hydrolyzed organosilanes or amino acid with silica without the need for chemical attack or mechanical abrasion, wherein the organo-trisilanol is generated from an organosilane.

### BACKGROUND OF THE INVENTION

Many substrates are by their nature hydrophobic. In some cases, hydrophobicity is due to naturally produced films. In other cases, substrates are intentionally made hydrophobic using chemicals and/or mechanical means for logistical purposes. And in still other cases the substrate becomes hydrophobic by a slow aging process. Examples of each are described below. The problem simply stated is that these surfaces become very difficult to treat and paint due to these surfaces' hydrophobic nature. Further, to make these hydrophobic surfaces paintable the surfaces must typically be mechanically and/or chemically attacked to yield a hydrophilic surface.

Elements capable of naturally producing hydrophobic films are known. These element's electrochemical behavior may be visualized on diagrams known as a Pourbaix diagram. Such diagram(s) map the element in and out of water regarding the elements' electrochemical potential over the possible pH range of water. Properties such as corrosion and passivity and immunity are observable in these Pourbaix diagrams. These regions of passivity identified in such diagrams are associated with oxides and hydrated oxides that form on the identified element(s). For example, aluminum is an amphoteric element which will corrode at lower and higher pHs—less than a pH of about 4 and greater than a pH of about 8. Within this pH range of about 4 to about 8, the aluminum is passive (meaning it does not react with water) due to the oxide that forms on the surface. Aluminum is highly reactive outside this range. Other elements, such as titanium and zirconium, share aluminum's affinity to naturally produce hydrophobic films.

Other elements that do not share aluminum's affinity to naturally produce hydrophobic films have to be made hydrophobic for transport purposes. International making and trading of metal is a fact of life in the world economy. Examples include the making and trading of metal coil such as hot dipped galvanized steel and other alloy steels such as Galvalume®. Such metals are typically produced in countries such as Vietnam and are shipped to the US. These metals must arrive in decent condition without being corroded otherwise such metal is rendered useless. To accomplish this feat passivating chemicals are applied before the metals are shipped. The chemistry of these passivating materials is mostly hexavalent chromium based, which is an undesirable carcinogen. Yet, these carcinogenic coatings do not guarantee that the metals will arrive at their destination in an uncorroded condition. As a result, international producers will typically apply additional material(s) over the passivating chemical film, such as water repelling oils and waxes. While the coating and additional material(s) will help get the metals to their destination with little if any corrosion, painting the hydrophobic surface of these metals is difficult.

Silicon-based compounds, such ashydr silanes and siloxanes, have been widely used in various industrial and commercial applications. Silanes are a class of compounds that contain a silicon atom covalently bonded to one or more groups, such as oxygen, nitrogen, or carbon.

One of the major challenges in using silane-based compounds to flip a surface from hydrophobic to hydrophilic is the difficulty in achieving a water break free surface. A water break free surface is a surface that water will sheet on uniformly and not pull back to show any unwetted surface. Such as is encountered when dishes are properly cleaned. Any surface showing the pull back of the water film is designated as having a water break. A water break free surface is therefore hydrophilic and is highly desirable in various industries, including the automotive, aerospace, and construction industries.

Currently, the methods used to achieve a water break free surface (i.e., a hydrophilic surface) include chemical and mechanical abrasion, which can be time-consuming, costly, and potentially harmful to the environment due to the resulting associated hazardous waste.

Thus, there is a need for a means to produce a hydrophilic surface from a hydrophobic surface without the significant cost of present methods.

### BRIEF SUMMARY OF THE INVENTION

To meet these and other needs, and in view of its purposes, a low-cost, aqueous treatment solution for altering the hydrophilicity of a surface is provided. For example, nano particulates, of which silica is an obvious example can be modified by the use of organosilanol, to produce a silanol modified nano particulate that can be combined with a polyphenol. This modified nano-particulate can be applied to a hydrophobic surface to convert that hydrophobic surface into a hydrophilic surface. Similarly, an amino acid and silica can be combined with the polyphenol, and optionally the organosilanol, to convert a surface to a hydrophilic surface. The advantages of such surface modification is that no extreme chemical or mechanical attack is required to achieve that hydrophilic condition. The baths used to create the hydrophilic surface are not contaminated. As a result, the surface is converted to a hydrophilic state. Further, since the surface beneath the hydrophilic layer is still intact, the corrosion resistant properties are not reduced as they would be for a chemically modified or mechanically abraded surface.

A silane modified nano particulate such as silica along with a polyphenol may be used to produce a hydrophilic surface without the use of extreme mechanical or chemical attack. Further, the processing bath is limited in loading of chromium and metal particulate. Further, any passivating surface chemistry is left intact to provide protection as it was originally intended.

Similarly, an amino acid and silica may be combined with a polyphenol and optionally the silane modified nano particulate to produce a hydrophilic surface without the use of extreme mechanical or chemical attack. Again, the processing bath is limited in loading of chromium and metal particulate and any passivating surface chemistry is left intact to provide protection as it was originally intended.

The silane used are hydrolyzed organosilanes, which may be ionic or non-ionic. One example of such hydrolized non-ionic organosilanes is organo-trisilanol. Organo-trisilanol is a non-ionic molecule containing a silicon atom, three hydroxyl groups, and an organic group. The hydroxyl groups on the silanol can react with surfaces to form chemical bonds, while the organic group can provide specific properties, such as hydrophilicity.

Organo-trisilanol may be generated from an organosilane, such as a trialkoxysilane or a trialkoxyalkoxysilane. Such organosilanes may be hydrolyzed and condensed under specific conditions to generate organo-trisilanol.

The composition can then be applied to various surfaces, including metal, ceramic, glass, and plastic surfaces. In certain embodiments, the organo-trisilanol modified nano particulate in the composition reacts with the surface to form chemical bonds, improving the surface's properties, such as hydrophilicity.

The method of the present invention comprises applying the composition of: a polyphenol; along with an amino acid and silica, an organo-trisilanol modified particulate or a combination thereof to a surface, optionally rinsing, then optionally allowing it to dry. The surface exhibits a water break free property, which can be confirmed by wetting with water to show a uniform wet surface, or by measuring the Wetting Tension with such devices as Dyne pens or use of a method such as ASTM D 2578.

### DETAILED DESCRIPTION OF THE INVENTION

As used in this document, the term “nano-particulate” means a composition of nano-sized particle(s). For example, this term relates to the maximum average dimension of particles having a size of less than about 1000 nm, particularly less than about 500 nm, more particularly between about 10 nm to about 500 nm. In one embodiment, the nano-sized particles may have a generally elongate shape and the maximum dimension is the length dimension of the particles.

As used in this document, the term “substantially homogeneous mixture” shall be interpreted to mean a mixture approaching uniform composition throughout.

As used in this document, the term “silica particles” refers to a plurality of discrete particles of oxide of silicon having the approximate chemical formula SiO₂, without regard to shape, morphology, porosity, and water or hydroxyl content.

As used in this document, the term “pretreatment composition” means any composition which improves the paint adhesion and corrosion resistance of a metal surface. Aqueous pretreatment compositions are used as a pretreatment before painting and may be used as a passivation treatment to reduce the formation of corrosion in the uncoated (unpainted) condition. Thus, although the composition may be called a pretreatment composition for convenience, it is a composition used for pretreatment (i.e., improving the adhesion of subsequently applied paint) and passivation (i.e., resisting corrosion of the unpainted surface).

As used in this document, the term “treating” shall mean applying a treatment, or cleaning, rinsing, and applying a pretreatment. The pretreatment also functions as a sealant to seal the metal surface, so the term “treating” shall optionally include the step of sealing the metal surface. Further, “treating” optionally can include process steps up through and including painting. For example, treatment steps may also include a step of applying a decorative coating, such as painting by electrocoating. After applying the pretreatment, the pretreatment may be rinsed first or dried-in-place before application of the paint. Each of these steps play a role in a final product's ability to resist corrosion and minimize paint loss. As mentioned above, the treatment composition can be used as a pre-paint treatment without the use of chromium.

As used in this document, the term “metal,” used for example in the phrase “metal surface,” includes aluminum, iron, zirconium, titanium, zinc, and combinations thereof. Each metal listed includes both the elemental metal and alloys thereof; for example, the term “aluminum” means aluminum and aluminum alloys. The term “alloy” is a metal in which the primary metal has the highest content of every other element or a content equal to the highest content of every other element, (e.g. an aluminum alloy being a metal in which aluminum is present in an amount at least equal to that of any other element). Iron alloys include cold rolled steel, electro-galvanized steel, and hot-dipped galvanized steel. In some embodiments, compositions of the present invention are used to treat a range of metals including alloys of copper, brass, magnesium, aluminum, and iron.

The nano-sized silica particles may be “monodispersed” in the nano-composite by not substantially agglomerating or clumping together with other nanoparticles.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

The composition and method comprises, consists essentially of, or consists of: (1) a hydrolyzed organosilane compound, an amino acid compound and silica, or a combination thereof; (2) a polyphenol and (3) water.

### Hydrolyzed Organosilane Compound

In certain embodiments, the composition and method comprises a non-ionic hydrolyzed organosilane compound having the formula (Y—R)ₙSi(OH)₃, where Y—R includes an organic moiety. For example, Y may be an amine group and R may be a C₃₋₆-alkyl group.

In other embodiments, Y—R may include n-alkanes which may be C₁-C₈; a hydroxyl group (OH); alkoxy group such as OCH₃, OCH₂CH₃. OCH₂CH₂CH₃; aromatic group such as C₆H₅; amine group such as NH₂, CH₂NH₂, CH₂CH₂NH₂, CH₂CH₂CH₂NH₂; vinyl group such as CHCH₂, CH₂CHCH₂, CH₂CHCH₂; epoxy group; acryl; methacryl; or mercaptyl.

Y—R may include functional or non-functional groups. Examples of functional groups include alkoxy, epoxy, methacrylic, acrylic, allyl, alkyd, phenyl, pyridyl, amino, mercaptyl, carboxyl or vinyl groups. Examples of non-functional alkyl groups include methyl and ethyl.

In certain embodiments, Y—R may include a polymerisable group, for example a polymerisable group as found in glycidoxypropyltrimethoxysilane, methacryloxypropyltrimethoxysilane, methacryloxypropyltriethoxysilane or mercaptopropyltrimethoxysilane.

In other embodiments, Y—R may be interrupted by —O—, —S—, or —NH—.

Indeed, the hydrolyzed organosilane compound of the present invention may start as an organosilane selected from the group comprising: 3-aminopropyltriethoxysilane, 3-glycidoxypropyltrimethoxysilane, p-aminophenyltrimethoxysilane, m-aminophenyltrimethoxysilane, allyltrimethoxysilane, n-(2-aminoethyl)-3-aminopropyltrimethoxysilane, 3-aminopropyltrimethoxysilane, 3-glycidoxypropyldiisopropylethoxysilane, (3-glycidoxypropyl)methyldiethoxysilane, 3-glycidoxypropyltrimethoxysilane, 3-mercaptopropyltrimethoxysilane, 3-mercaptopropyltriethoxysilane, 3-methacryloxypropylmethyldiethoxysilane, methacryloxypropyltriethoxysilane, 3-methacryloxypropylmethyldimethoxysilane, 3-methacryloxypropyltrimethoxysilane, n-phenylaminopropyltrimethoxysilane, vinylmethyldiethoxysilane, vinyltriethoxysilane, vinyltrimethoxysilane, and mixtures thereof. Other suitable starter organosilanes may include: Tetraethyl orthosilicate, 1,6-Bis(trichlorosilyl)hexane, Tetrabutyl orthosilicate, (3-Bromopropyl) trichlorosilane, Tetramethyl orthosilicate, Butyltrichlorosilane, Tetramethyl orthosilicate, 3-Cyanopropyltrichlorosilane, Tetrapropyl orthosilicate, Decyltrichlorosilane, 3-(Trimethoxysilyl) propyl acrylate, [3-(Heptafluoroisopropoxy)propyl]trichlorosilane, Tris(tert-butoxy)silanol, (2-Methylene-1,3-propanediyl)bis[trichlorosilane], Tris(tert-pentoxy)silanol, 7-Octenyltrichlorosilane, Ethoxydiphenylvinylsilane, Pentyltrichlorosilane, 3-Glycidoxypropyldimethylethoxysilane, Trichloro[2-(chloromethyl)allyl]silane, Methoxy(dimethyl)octylsilane, Trichloro[4-(chloromethyl)phenyl]silane, 3-Aminopropyl(diethoxy)methylsilane, Trichloro(3-chloropropyl)silane, (3-Chloropropyl)dimethoxymethylsilane, Trichlorocyclohexylsilane, Cyclohexyl(dimethoxy)methylsilane, Trichlorocyclopentylsilane, Diethoxydiphenylsilane, Trichlorododecylsilane, Diethoxy(3-glycidyloxypropyl)methylsilane, Trichloro(hexyl)silane, Diethoxymethyloctadecylsilane, Trichloro(isobutyl)silane, Diethoxy(methyl)phenylsilane, Trichloro(octadecyl)silane, 3-Glycidoxypropyldimethoxymethylsilane, Trichloro(octyl)silane, (3-Mercaptopropyl) methyldimethoxysilane, Trichloro(phenethyl)silane, Allyltriethoxysilane, Trichloro(phenyl)silane, Allyltrimethoxysilane, Trichloro(propyl)silane, 3-[2-(2-Aminoethylamino)ethylamino]propyl-trimethoxysilane, 2-(Trichlorosilyl)ethyl acetate, [3-(2-Aminoethylamino)propyl]trimethoxysilane, Trichloro(3,3,3-trifluoropropyl)silane, (3-Aminopropyl)triethoxysilane, Ethoxy(dimethyl)vinylsilane, Bis (3-(methylamino)propyl)trimethoxysilane, Ethoxytrimethylsilane, (3-Chloropropyl)triethoxysilane;

Methoxytrimethylsilane, (3-Chloropropyl)trimethoxysilane, Diethoxydimethylsilane, (2-Cyanoethyl)triethoxysilane, Diethoxy(methyl)vinylsilane, 3-Cyanopropyltriethoxysilane, 1,3-Diethoxy-1,1,3,3-tetramethyldisiloxane, (3-Diethylaminopropyl)trimethoxysilane, Dimethoxydimethylsilane, (N,N-Dimethylaminopropyl)trimethoxysilane, Dimethoxydimethylsilane, Dimethyloctadecyl[3-(trimethoxysilyl)propyl]ammonium chloride, Dimethoxymethylvinylsilane, 2-(3,4-Epoxycyclohexyl)ethyl-trimethoxysilane, 1,2-Bis(triethoxysilyl)ethane, (3-Glycidyloxypropyl) trimethoxysilane, 1,2-Bis(trimethoxysilyl)ethane, Isobutyl(trimethoxy)silane, (Chloromethyl)triethoxysilane, (3-Mercaptopropyl)trimethoxysilane, 1,3-Dimethyltetramethoxydisiloxane, N-Propyltriethoxysilane, Ethyltrimethoxysilane, Triethoxy(isobutyl)silane, Triethoxy(ethyl)silane, Triethoxy(3-isocyanatopropyl)silane, Triethoxymethylsilane, Triethoxy(octyl)silane, Triethoxymethylsilane, Triethoxyphenylsilane, Triethoxy(vinyl)silane, Trimethoxy[3-(methylamino)propyl]silane, Trimethoxymethylsilane, Trimethoxy(octadecyl)silane, Trimethoxymethylsilane, Trimethoxy(7-octen-1-yl) silane, Trimethoxy(vinyl)silane, Trimethoxy (octyl)silane, Trimethoxy(vinyl)silane, Trimethoxy[3-(phenylamino)propyl]silane, Bis(trichlorosilyl)acetylene, Trimethoxy(2-phenylethyl)silane, 1,2-Bis(trichlorosilyl)ethane, Trimethoxyphenylsilane, Bis(trichlorosilyl)methane, Trimethoxy(propyl)silane, tert-Butyltrichlorosilane, Trimethoxy(propyl)silane, Ethyltrichlorosilane, 3-(Trimethoxysilyl)propyl acrylate, Hexachlorodisilane, 3-(Trimethoxysilyl) propyl methacrylate, Hexachlorodisiloxane, 1-[3-(Trimethoxysilyl) propyl]urea, Methyltrichlorosilane, Tris[3-(trimethoxysilyl)propyl]isocyanurate, Methyltrichlorosilane, Allyltrichlorosilane, Trichloro(dichloromethyl)silane, Benzyltrichlorosilane, Trichloro(trichloromethyl)silane, Trichloro(vinyl)silane.

### Amino Acid

In certain embodiments, the composition and method includes an amino acid, having the general formula H₂NCHRCOOH where R includes an organic moiety. For example, R can be an isopropyl or sec-butyl group. In other embodiments, R may include aromatic group such as C₆H₅; phenolic group such as C₆H₅OH; hydroxyl group (OH); amine group such as NH₂, CH₂NH₂, CH₂CH₂NH₂, CH₂CH₂CH₂NH₂; mercapto; carboxyl.

In other embodiments, the amino acid comprises an inorganic moiety such as HSO₃, such as sulfamic acid.

Indeed, the amino acid compound of the present invention may start as an amino acid selected from the group comprising: sulfamic acid, alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, y-Aminobutyric acid, pyrrolysine, 4-hydroxyproline, 5-hydroxylysine, homoserine, homocysteine, ornithine, statine.

### Polyphenol

The composition and method comprises a polyphenol. Polyphenols include four principal classes: phenolic acids, flavonoids, stilbenes, and lignans.

The polyphenol compound of the present invention may start as a polyphenol selected from the group comprising: tannic acid, gallic acid, castalagin, castalin, ellagic acid, curcumin, theaflavin, catechin, epicatechin, epigallocatechin, quercetin, kaempferol, galangin, fisetin, myricetin, cinnamic acid, p-coumaric acid, caffeic acid, ferulic acid, sinapic acid, gentisic acid, vanillic acid, gallic acid, syringic acid, protocatechuic acid, resveratrol, piceatannol, rhapontigenin, isorhapontigenin, pinosylvin, pterostilbene

### Method of Producing Hydrolyzed Organosilane Compound

The method to produce the hydrolyzed organosilane compound may comprise the step of condensing silicon hydroxide molecules to thereby form the hydrolyzed nano-sized silica particles. For example, the method may comprise the step of providing silica precursors to the substantially homogeneous mixture. The silica precursor may then undergo a hydrolysis reaction to form silicon hydroxide. Hence, in one embodiment of the disclosed method, the silicon hydroxide molecules may be derived from hydrolyzing silica precursors that are provided to the substantially homogeneous mixture. The water for the hydrolysis reaction may be extracted from an alkaline catalyst solution.

The silicon hydroxide molecules may then undergo a condensation reaction in the presence of an alkaline catalyst to form the hydrolyzed nano-sized silica particles. The silica precursor may comprise silicon alkoxide. The silicon alkoxide may be of the following formula Si(OR)ₙ, in which R is an C₁₋₆ alkyl group and n is either 3 or 4. When n is 3, the silicon alkoxide is a trialkoxysilane and may be selected from the group consisting of trimethoxysilane, triethoxysilane, tripropoxysilane, tributoxysilane, tripentoxysilane and trihexoxysilane. When n is 4, the silicon alkoxide is a tetraalkoxysilane and may be selected from the group consisting of, tetramethoxysilane, tetraethoxysilane (or commonly known as tetraethyl orthosilicate, TEOS), tetrapropoxysilane, tetrabutoxysilane, tetrapentoxysilane and tetrahexoxysilane.

When an alkaline catalyst is employed the alkaline catalyst may contain an ammonium cation (when in the presence of water molecules). Hence, the catalyst may be selected from the group consisting of ammonia, ammonium hydroxide and alkylamine such as methylamine and ethylamine. The catalyst may be capable of catalyzing the hydrolysis of silicon hydroxide to form the hydrolyzed nano-sized silica particles while, at the same time, catalyze the condensation reaction between the hydrolyzed nano-sized silica particles and hydrolyzed organo-silane agent to form a surface-functionalized nano-sized silica particles. The surface functionality of the nano-sized silica particles may aid in promoting dispersion of the nano-sized silica particle in the matrix.

In certain embodiments, a silica precursor such as tetraethoxysilane (TEOS) or aminopropyltrimethoxysilane (APTMS) are hydrolyzed by hydroxyl groups of H₂O that come from an ammonia solution to form silicon hydroxide or a hydrolyzed APTMS, respectively.

It is to be noted that the water molecules do not serve as a solvent in the homogeneous mixture, but are present in the reaction scheme as one of the reactants for a solvent-free process. After that, the hydrolyzed nano-sized silica particles are formed via condensation reaction of silicon hydroxide molecules in the presence of the ammonia catalyst solution. The hydrolyzed nano-sized silica particles undergo nucleation and growth to form oval-shaped hydrolyzed nano-sized silica particles. The hydrolyzed APTMS molecules and hydrolyzed nano-sized silica particles then undergo a condensation reaction in the presence of the ammonia catalyst solution to form surface-functionalized nano-sized silica particles such as surface-aminated nano-sized silica particles. In this condensation step, the NH₃ molecules act as a catalyst to accelerate the condensation of hydrolyzed TEOS and APTMS. These NH₃ molecules are recovered back after the condensation reaction because it serves as a catalyst.

In the exemplary production process, if the ammonia solution is not present, the nano-sized silica particles would not be formed because the water molecules (H₂O) and alkaline catalyst (NH₃ molecules) are requisite components for a solvent-free process of silica. In the absence of NH₃ molecules (that is, only water is present), the nucleation and growth mechanisms of the hydrolyzed nano-sized silica particles will be affected, resulting in non-homogeneous silica dispersion, large aggregation of silica and non-uniform morphology of silica particles. Therefore, in certain embodiments, NH₃ molecules may be necessary in order to achieve elongated nano-sized silica particles that are uniformly dispersed and have a substantially uniform morphology.

The average particle size of the nano-sized silica particles may be less than 1000 nm and more preferably selected from the range consisting of about 10 nm to about 500 nm, about 50 nm to about 500 nm, about 100 nm to about 500 nm, about 150 nm to about 500 nm, about 200 nm to about 500 nm, about 250 nm to about 500 nm, about 300 nm to about 500 nm, about 350 nm to about 500 nm, about 400 nm to about 500 nm, about 450 nm to about 500 nm, about 10 nm to about 50 nm, about 10 nm to about 100 nm, about 10 nm to about 150 nm, about 10 nm to about 200 nm, about 10 nm to about 250 nm, about 10 nm to about 300 nm, about 10 nm to about 350 nm, about 10 nm to about 400 nm and about 10 nm to about 450 nm. In one embodiment, the average particle size of the nano-sized silica particles may be selected from the range of about 10 nm to about 500 nm.

The particle size of the nano-sized silica particles may be controlled by controlling the nucleation number, which is in turn controlled by the process kinetics and temperature. As the nano-sized silica particles are being formed, the silica particles are subjected to an agitating step. The agitating step aids in substantially preventing the aggregation of the nano-sized silica particles such that they stay in the nano-scale and do not form micro-particles. The nano-sized silica particles may also be stabilized due to the linkage with the polymer matrix.

The wt % of the nano-sized silica particles present in the composition may be selected from the range consisting of about 0.1 wt % to about 10 wt %, about 1 wt % to about 10 wt %, about 2 wt % to about 10 wt %, about 3 wt % to about 10 wt %, about 4 wt % to about 10 wt %, about 5 wt % to about 10 wt %, about 6 wt % to about 10 wt %, about 7 wt % to about 10 wt %, about 8 wt % to about 10 wt %, about 9 wt % to about 10 wt %, about 0.1 wt % to about 1 wt %, about 0.1 wt % to about 2 wt %, about 0.1 wt % to about 3 wt %, about 0.1 wt % to about 4 wt %, about 0.1 wt % to about 5 wt %, about 0.1 wt % to about 6 wt %, about 0.1 wt % to about 7 wt %, about 0.1 wt % to about 8 wt % and about 0.1 wt % to about 9 wt %, based on the weight of the nano-composite. In one embodiment, the wt % of the nano-sized silica particles may be selected from the range of about 0.1 wt % to about 10 wt %.

### Additional Components

The compositions may additionally include constituents that do not affect the basic and novel characteristics of the compositions. For example, a stabilizing agent may be added to improve the shelf-life and stability of the compositions. Stabilizing agents, such as ammonium biborate, may be particularly useful for this purpose. Without being held to the theory, it is believed that the stabilizing agent ties up any free fluoride and buffers the solution, which prevents the reaction of the free fluoride with other elements in the solution. Components such as, for example, stabilizing agents may be added to the compositions without affecting the basic and novel characteristics.

The concentrations of the constituents of the compositions, as well as the application temperature and residence time, can vary over a wide range and can be modified in a known manner, depending on the desired coating weight. In addition, the desired coating weight will be a function of the type of metal, the timing of processing after application of the pretreatment, the environmental conditions to which the treated metal is exposed, and the type of decorative coating used, among other factors. The coating process can be effected by spray, immersion, or flow coating techniques. The amount of coating should be sufficient to achieve the desired characteristics of the dried metal for its intended use. The amount of coating desired is from about 1.0 to 40.0 milligrams of the dried coating per each square foot of dried metal surface. By using a solution of higher concentrations, it is possible to leave the desired amount of the dried coating with shorter treatment times and/or lower temperatures.

Component concentrations of a working bath of the present metal pretreatment can vary over a wide range. Appropriate concentration ranges of the various components are primarily dependent upon their solubilities. Above the solubility limits, the solute may begin to come out of the solution. At concentrations too low, there are insufficient amounts of the constituents to achieve the desired coating weight in a reasonable time and to perform their functions. Additionally, while these compositions may be provided as a concentrate, they are generally utilized as a dilution with distilled water.

In certain embodiments, inorganic mineral acids, such as hydrofluoric, sulfuric, or nitric, may be added to the solution so as to provide chemical attack on the passivated metal surface.

In other embodiments, surfactants could be added to clean the metal surface of dirt and oil.

### pH Range

While the pH of present metal treatments can vary over a wide range, as mentioned above this composition may be non-ionic. Specifically, the pH of the composition may be in the range of about 6 to about 8. However, in other embodiments, the produced material is utilizable over a very broad range of pH from acidic to alkaline without regard to ionic state. Specifically, the pH of the composition may be in the range from below 6 to above 8.

Here, the present metal treatment contains, if any, undetectable traces of metal ions such as chromium.

### Application

Compositions according to the invention may be made by mixing the ingredients in any of a number of sequences. The order of addition of the constituents is not critical.

Treatment of metal surfaces according to the invention typically includes contacting the metal surface with an aqueous pretreatment composition consisting essentially of water and hydrolyzed organosilanes, and optionally stabilizing agents, wherein the composition is non-ionic. The processes may additionally include, before the rinsing step, the step of cleaning the metal surface with an aqueous cleaner and rinsing. The processes may further include, after contacting the metal surface with the aqueous pretreatment composition, the steps of rinsing the metal surface with water and then painting the surface of the metal. Alternatively, the pretreatment composition may be dried-in-place (i.e., not rinsed), then painted.

Contacting of the metal surface may be performed by any known coating technique, including for example spraying, immersing, roll coating, or flow coating. Optionally, after contacting the rinsed metal surface with a composition comprising water and hydrolyzed organosilanes, the metal surface is dried and then a decorative coating (e.g., paint) is applied, without rinsing between these steps. Thus, the pretreatment is a “dried-in-place” pretreatment in this embodiment.

The cleaning step removes oil and other contaminants from the surface of the metal, and is typically effected by immersing the metal surface in a bath of an alkaline cleaning solution to form a cleaned metal surface. The alkaline cleaning solution may be an aqueous solution of a silicated alkaline cleaning agent. Such an alkaline cleaning solution is sold by Bulk Chemicals Inc., Reading, Pennsylvania, under the brand name Bulk Kleen®. Some exemplary alkaline cleaning agents which can be used according to the present invention include sodium carbonate, sodium hydroxide, and potassium hydroxide. In one embodiment, the cleaner will be a silicated, alkaline, and non-etching cleaner. In some cases, cleaning may not be required at all, and this step may be omitted.

A metal surface which has been contacted by a silicated alkaline cleaning solution is called a “cleaned metal surface.” It is cleaned in the sense that it has been exposed to the silicated alkaline cleaning solution. It is not completely free of contaminants, however, inasmuch as vestiges of the bath and other impurities may remain. Only after it is rinsed with water can it be viewed as fully cleaned and ready to make contact with a pretreatment composition (i.e., substantially all of the impurities are, by that point, removed). The rinsing step is a conventional water rinsing step, in one embodiment using deionized water, to remove any excess cleaner or detergent left on the metal surface from the cleaning step. The use of deionized water avoids the introduction of any deleterious ions, such as chloride ions, into the system. After the metal surface is rinsed, it is treated with an aqueous composition of the sort described above according to the invention.

One coating technique is reverse roll coating, whereby a sheet of metal is pulled between counter-rotating cylinders, which are rotating against the direction of travel of the sheet being unrolled. The solution is rolled down along these cylinders until it contacts the metal. As the sheet metal is passed between the cylinders in a direction against the direction of rotation of the cylinders, some wiping force is applied to the metal. Another conventional method is known as the quick-dip method, whereby sheet metal is dipped into a batch containing the coating composition and is subsequently passed between two rolls to remove the excess. The concentration, temperature, and pH of the bath are interrelated. In one embodiment, the bath temperature during this contacting step is about 70° F. to about 150° F., although the temperature can vary over a wide range depending on concentration and pH. The bath pH depends on the particular pretreatment composition used.

After pretreatment, the metal may then be dried (e.g., by blown air or by an oven). The temperatures for the drying operation may range from about 60° F. to about 500° F. The length of the drying step will depend upon the temperature utilized. In addition, air may be blown over the metal to enhance the evaporation.

The desirable performance characteristics of the present invention can be achieved by the processing steps described above to produce a pretreated metal surface with good paint adhesion and corrosion resistance. These characteristics are obtained on the metal surface without a decorative coating. Accordingly, the treated metal surface can be used as unpainted products and will exhibit corrosion resistance even if there is a delay between the treatment steps and any subsequent painting.

A decorative paint coating may be applied to the dried metal surface. Typical non-limiting examples of decorative coatings include paints and lacquers, including electrocoated paints. Suitable paints are available from a number of vendors. A top coat may be applied to the treated metal surface, either as a treated surface or as a treated and painted surface. For example, a suitable polyester triglycidyl isocyanurate (TGIC) powder coating top coat is sold by DuPont of Wilmington, Delaware, under the tradename Alesta® AR. Typically, no rinsing is performed after contacting the rinsed metal surface with the treatment composition and application of the decorative coating. In this way, the generation of waste is minimized. The dried-in-place composition of the present invention serves to adhere the paint or lacquer to the metal and to minimize corrosion.

The methods and compositions of the present invention can be applied in a wide variety of applications. These applications include, as non-limiting examples, extrusion applications and coil coating.

In sum, the present invention provides environmentally friendly compositions and processes for converting a surface from a hydrophobic surface to a hydrophilic surface, which provides excellent paint adhesion and corrosion resistance. More particularly, the present invention avoids the use of metals (e.g., trivalent and hexavalent chromium), and its associated health hazards and disposal problems.

The compositions and processes of the present invention provide these benefits without the use of additional components which effect the basic and novel characteristics of the invention. Other components, when added to the composition in sufficient amounts, may affect the novel characteristics. For example, certain components may make the compositions unstable. Such components may cause the solution to polymerize and affect the shelf-life of the treatment. Other components may degrade the performance of the compositions and processes of the present invention.

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges. It is also expressly intended that the steps of the methods of using the various compositions disclosed above are not restricted to any particular order.

What is claimed is:

1. A metal-free aqueous treatment solution for converting a hydrophobic metal surface to a hydrophilic metal surface, the solution comprising:
water,
a particulate modified by a hydrolyzed organosilane, an amino acid, silica, or a combination thereof, and
a polyphenol.

2. The solution of claim 1, wherein
the organosilane has a formula (Y—R)ₙSi(OH)₃, and Y—R includes an organic moiety.

3. The solution of claim 2, wherein
Y is an amine moiety and R is a C₃₋₆-alkyl moiety.

4. The solution of claim 2, wherein the solution includes both a particulate modified by a hydrolyzed organosilane and an amino acid.

5. The solution of claim 4, wherein
Y—R includes at least two moieties selected from the group consisting of:
a n-alkane moiety selected from a group consisting of C₁-C₈ alkanes;
a hydroxyl moiety;
an alkoxy moiety selected from the group consisting of OCH₃, OCH₂CH₃. OCH₂CH₂CH₃;
an aromatic moiety having a phenyl ring;
an amine moiety selected from a group consisting of NH₂, CH₂NH₂, CH₂CH₂NH₂, CH₂CH₂CH₂NH₂;
a vinyl moiety selected from a group consisting of CHCH₂, CH₂CHCH₂, CH₂CHCH₂;
an epoxy moiety;
an acryl moiety;
a methacryl moiety;
a mercaptyl moiety; or.
a polymerisable moiety.

6. The solution of claim 5 wherein Y—R is selected from the group consisting of glycidoxypropyltrimethoxysilane, methacryloxypropyltrimethoxysilane, methacryloxypropyltriethoxysilane or mercaptopropyltrimethoxysilane.

7. The solution of claim 4, wherein the organosilane is selected from the group consisting of: 3-aminopropyltriethoxysilane, 3-glycidoxypropyltrimethoxysilane, p-aminophenyltrimethoxysilane, m-aminophenyltrimethoxysilane, allyltrimethoxysilane, n-(2-aminoethyl)-3-aminopropyltrimethoxysilane, 3-aminopropyltrimethoxysilane, 3-glycidoxypropyldiisopropylethoxysilane, (3-glycidoxypropyl) methyldiethoxysilane, 3-glycidoxypropyltrimethoxysilane, 3-mercaptopropyltrimethoxysilane, 3-mercaptopropyltriethoxysilane, 3-methacryloxypropylmethyldiethoxysilane, methacryloxypropyltriethoxysilane, 3-methacryloxypropylmethyldimethoxysilane, 3-methacryloxypropyltrimethoxysilane, n-phenylaminopropyltrimethoxysilane, vinylmethyldiethoxysilane, vinyltriethoxysilane, vinyltrimethoxysilane, and mixtures thereof. Other suitable starter organosilanes may include: Tetraethyl orthosilicate, 1,6-Bis(trichlorosilyl)hexane, Tetrabutyl orthosilicate, (3-Bromopropyl)trichlorosilane, Tetramethyl orthosilicate, Butyltrichlorosilane, Tetramethyl orthosilicate, 3-Cyanopropyltrichlorosilane, Tetrapropyl orthosilicate, Decyltrichlorosilane, 3-(Trimethoxysilyl)propyl acrylate, [3-(Heptafluoroisopropoxy)propyl]trichlorosilane, Tris(tert-butoxy) silanol, (2-Methylene-1,3-propanediyl) bis[trichlorosilane], Tris(tert-pentoxy)silanol, 7-Octenyltrichlorosilane, Ethoxydiphenylvinylsilane, Pentyltrichlorosilane, 3-Glycidoxypropyldimethylethoxysilane, Trichloro[2-(chloromethyl)allyl]silane, Methoxy(dimethyl)octylsilane, Trichloro[4-(chloromethyl)phenyl]silane, 3-Aminopropyl(diethoxy)methylsilane, Trichloro(3-chloropropyl)silane, (3-Chloropropyl)dimethoxymethylsilane, Trichlorocyclohexylsilane, Cyclohexyl(dimethoxy)methylsilane, Trichlorocyclopentylsilane, Diethoxydiphenylsilane, Trichlorododecylsilane, Diethoxy(3-glycidyloxypropyl)methylsilane, Trichloro(hexyl)silane, Diethoxymethyloctadecylsilane, Trichloro(isobutyl)silane, Diethoxy(methyl)phenylsilane, Trichloro(octadecyl)silane, 3-Glycidoxypropyldimethoxymethylsilane, Trichloro(octyl)ilane, (3-Mercaptopropyl)methyldimethoxysilane, Trichloro(phenethyl)silane, Allyltriethoxysilane, Trichloro(phenyl)silane, Allyltrimethoxysilane, Trichloro(propyl)silane, 3-[2-(2-Aminoethylamino)ethylamino]propyl-trimethoxysilane, 2-(Trichlorosilyl)ethyl acetate, [3-(2-Aminoethylamino)propyl]trimethoxysilane, Trichloro(3,3,3-trifluoropropyl)silane, (3-Aminopropyl)triethoxysilane, Ethoxy(dimethyl)vinylsilane, Bis(3-(methylamino)propyl)trimethoxysilane, Ethoxytrimethylsilane, (3-Chloropropyl)triethoxysilane; Methoxytrimethylsilane, (3-Chloropropyl)trimethoxysilane, Diethoxydimethylsilane, (2-Cyanoethyl)triethoxysilane, Diethoxy(methyl)vinylsilane, 3-Cyanopropyltriethoxysilane, 1,3-Diethoxy-1,1,3,3-tetramethyldisiloxane, (3-Diethylaminopropyl)trimethoxysilane, Dimethoxydimethylsilane, (N,N-Dimethylaminopropyl)trimethoxysilane, Dimethoxydimethylsilane, Dimethyloctadecyl[3-(trimethoxysilyl)propyl]ammonium chloride, Dimethoxymethylvinylsilane, 2-(3,4-Epoxycyclohexyl)ethyl-trimethoxysilane, 1,2-Bis(triethoxysilyl)ethane, (3-Glycidyloxypropyl)trimethoxysilane, 1,2-Bis(trimethoxysilyl)ethane, Isobutyl(trimethoxy)silane, (Chloromethyl)triethoxysilane, (3-Mercaptopropyl)trimethoxysilane, 1,3-Dimethyltetramethoxydisiloxane, N-Propyltriethoxysilane, Ethyltrimethoxysilane, Triethoxy(isobutyl)silane, Triethoxy(ethyl)silane, Triethoxy(3-isocyanatopropyl)silane, Triethoxymethylsilane, Triethoxy(octyl)silane, Triethoxymethylsilane, Triethoxyphenylsilane, Triethoxy(vinyl)silane, Trimethoxy[3-(methylamino)propyl]silane, Trimethoxymethylsilane, Trimethoxy(octadecyl)silane, Trimethoxymethylsilane, Trimethoxy(7-octen-1-yl)silane, Trimethoxy(vinyl)silane, Trimethoxy(octyl)silane, Trimethoxy(vinyl)silane, Trimethoxy[3-(phenylamino)propyl]silane, Bis(trichlorosilyl)acetylene, Trimethoxy(2-phenylethyl)silane, 1,2-Bis(trichlorosilyl)ethane, Trimethoxyphenylsilane, Bis(trichlorosilyl)methane, Trimethoxy(propyl)silane, tert-Butyltrichlorosilane, Trimethoxy(propyl)silane, Ethyltrichlorosilane, 3-(Trimethoxysilyl)propyl acrylate, Hexachlorodisilane, 3-(Trimethoxysilyl)propyl methacrylate, Hexachlorodisiloxane, 1-[3-(Trimethoxysilyl)propyl]urea, Methyltrichlorosilane, Tris[3-(trimethoxysilyl)propyl]isocyanurate, Methyltrichlorosilane, Allyltrichlorosilane, Trichloro(dichloromethyl)silane, Benzyltrichlorosilane, Trichloro(trichloromethyl)silane, and Trichloro(vinyl)silane.

8. The solution of claim 4, wherein the amino acid has the general formula H₂NCHRCOOH where R is an organic moiety.

9. The solution of claim 1, wherein the polyphenol is a phenolic acid.

10. The solution of claim 1, wherein the polyphenol is selected from the group consisting of tannic acid, gallic acid, castalagin, castalin, ellagic acid, curcumin, theaflavin, catechin, epicatechin, epigallocatechin, quercetin, kaempferol, galangin, fisetin, myricetin, cinnamic acid, p-coumaric acid, caffeic acid, ferulic acid, sinapic acid, gentisic acid, vanillic acid, gallic acid, syringic acid, protocatechuic acid, resveratrol, piceatannol, rhapontigenin, isorhapontigenin, pinosylvin, and pterostilbene.

11. A metal-free aqueous treatment solution for converting a hydrophobic metal surface to a hydrophilic metal surface, the solution consisting essentially of:
water,
a particulate modified by a hydrolyzed organosilane, an amino acid, silica, or a combination thereof, and
a polyphenol.

12. The solution of claim 1, wherein
the organosilane has a formula (Y—R)ₙSi(OH)₃, and Y—R includes an organic moiety.

13. The solution of claim 2, wherein
Y is an amine moiety and R is a C₃₋₆-alkyl moiety.

14. The solution of claim 2, wherein the solution includes both a particulate modified by a hydrolyzed organosilane and an amino acid.

15. The solution of claim 4, wherein
Y—R includes at least two moieties selected from the group consisting of:
a n-alkane moiety selected from a group consisting of C₁-C₈ alkanes;
a hydroxyl moiety;
an alkoxy moiety selected from the group consisting of OCH₃, OCH₂CH₃. OCH₂CH₂CH₃;
an aromatic moiety having a phenyl ring;
an amine moiety selected from a group consisting of NH₂, CH₂NH₂, CH₂CH₂NH₂, CH₂CH₂CH₂NH₂;
a vinyl moiety selected from a group consisting of CHCH₂, CH₂CHCH₂, CH₂CHCH₂;
an epoxy moiety;
an acryl moiety;
a methacryl moiety;
a mercaptyl moiety; or.
a polymerisable moiety.

16. The solution of claim 5 wherein Y—R is selected from the group consisting of glycidoxypropyltrimethoxysilane, methacryloxypropyltrimethoxysilane, methacryloxypropyltriethoxysilane or mercaptopropyltrimethoxysilane.

17. The solution of claim 4, wherein the organosilane is selected from the group consisting of: 3-aminopropyltriethoxysilane, 3-glycidoxypropyltrimethoxysilane, p-aminophenyltrimethoxysilane, m-aminophenyltrimethoxysilane, allyltrimethoxysilane, n-(2-aminoethyl)-3-aminopropyltrimethoxysilane, 3-aminopropyltrimethoxysilane, 3-glycidoxypropyldiisopropylethoxysilane, (3-glycidoxypropyl) methyldiethoxysilane, 3-glycidoxypropyltrimethoxysilane, 3-mercaptopropyltrimethoxysilane, 3-mercaptopropyltriethoxysilane, 3-methacryloxypropylmethyldiethoxysilane, methacryloxypropyltriethoxysilane, 3-methacryloxypropylmethyldimethoxysilane, 3-methacryloxypropyltrimethoxysilane, n-phenylaminopropyltrimethoxysilane, vinylmethyldiethoxysilane, vinyltriethoxysilane, vinyltrimethoxysilane, and mixtures thereof. Other suitable starter organosilanes may include: Tetraethyl orthosilicate, 1,6-Bis(trichlorosilyl)hexane, Tetrabutyl orthosilicate, (3-Bromopropyl)trichlorosilane, Tetramethyl orthosilicate, Butyltrichlorosilane, Tetramethyl orthosilicate, 3-Cyanopropyltrichlorosilane, Tetrapropyl orthosilicate, Decyltrichlorosilane, 3-(Trimethoxysilyl)propyl acrylate, [3-(Heptafluoroisopropoxy)propyl]trichlorosilane, Tris(tert-butoxy)silanol, (2-Methylene-1,3-propanediyl)bis[trichlorosilane], Tris(tert-pentoxy)silanol, 7-Octenyltrichlorosilane, Ethoxydiphenylvinylsilane, Pentyltrichlorosilane, 3-Glycidoxypropyldimethylethoxysilane, Trichloro[2-(chloromethyl)allyl]silane, Methoxy(dimethyl)octylsilane, Trichloro[4-(chloromethyl)phenyl]silane, 3-Aminopropyl(diethoxy)methylsilane, Trichloro(3-chloropropyl)silane, (3-Chloropropyl)dimethoxymethylsilane, Trichlorocyclohexylsilane, Cyclohexyl(dimethoxy)methylsilane, Trichlorocyclopentylsilane, Diethoxydiphenylsilane, Trichlorododecylsilane, Diethoxy(3-glycidyloxypropyl)methylsilane, Trichloro(hexyl)silane, Diethoxymethyloctadecylsilane, Trichloro(isobutyl)silane, Diethoxy(methyl)phenylsilane, Trichloro(octadecyl)silane, 3-Glycidoxypropyldimethoxymethylsilane, Trichloro(octyl)silane, (3-Mercaptopropyl)methyldimethoxysilane, Trichloro(phenethyl)silane, Allyltriethoxysilane, Trichloro(phenyl)silane, Allyltrimethoxysilane, Trichloro(propyl)silane, 3-[2-(2-Aminoethylamino)ethylamino]propyl-trimethoxysilane, 2-(Trichlorosilyl)ethyl acetate, [3-(2-Aminoethylamino)propyl]trimethoxysilane, Trichloro (3,3,3-trifluoropropyl)silane, (3-Aminopropyl)triethoxysilane, Ethoxy(dimethyl)vinylsilane, Bis(3-(methylamino)propyl)trimethoxysilane, Ethoxytrimethylsilane, (3-Chloropropyl) triethoxysilane; Methoxytrimethylsilane, (3-Chloropropyl) trimethoxysilane, Diethoxydimethylsilane, (2-Cyanoethyl)triethoxysilane, Diethoxy(methyl)vinylsilane, 3-Cyanopropyltriethoxysilane, 1,3-Diethoxy-1,1,3,3-tetramethyldisiloxane, (3-Diethylaminopropyl)trimethoxysilane, Dimethoxydimethylsilane, (N,N-Dimethylaminopropyl)trimethoxysilane, Dimethoxydimethylsilane, Dimethyloctadecyl[3-(trimethoxysilyl)propyl]ammonium chloride, Dimethoxymethylvinylsilane, 2-(3,4-Epoxycyclohexyl) ethyl-trimethoxysilane, 1,2-Bis (triethoxysilyl)ethane, (3-Glycidyloxypropyl)trimethoxysilane, 1,2-Bis (trimethoxysilyl)ethane, Isobutyl(trimethoxy)silane, (Chloromethyl)triethoxysilane, (3-Mercaptopropyl)trimethoxysilane, 1,3-Dimethyltetramethoxydisiloxane, N-Propyltriethoxysilane, Ethyltrimethoxysilane, Triethoxy(isobutyl)silane, Triethoxy(ethyl)silane, Triethoxy(3-isocyanatopropyl)silane, Triethoxymethylsilane, Triethoxy(octyl)silane, Triethoxymethylsilane, Triethoxyphenylsilane, Triethoxy(vinyl)silane, Trimethoxy[3-(methylamino)propyl]silane, Trimethoxymethylsilane, Trimethoxy(octadecyl)silane, Trimethoxymethylsilane, Trimethoxy(7-octen-1-yl)silane, Trimethoxy(vinyl)silane, Trimethoxy(octyl)silane, Trimethoxy(vinyl)silane, Trimethoxy[3-(phenylamino)propyl]silane, Bis(trichlorosilyl)acetylene, Trimethoxy(2-phenylethyl)silane, 1,2-Bis(trichlorosilyl)ethane, Trimethoxyphenylsilane, Bis(trichlorosilyl)methane, Trimethoxy(propyl)silane, tert-Butyltrichlorosilane, Trimethoxy(propyl)silane, Ethyltrichlorosilane, 3-(Trimethoxysilyl)propyl acrylate, Hexachlorodisilane, 3-(Trimethoxysilyl)propyl methacrylate, Hexachlorodisiloxane, 1-[3-(Trimethoxysilyl)propyl]urea, Methyltrichlorosilane, Tris[3-(trimethoxysilyl)propyl]isocyanurate, Methyltrichlorosilane, Allyltrichlorosilane, Trichloro(dichloromethyl) silane, Benzyltrichlorosilane, Trichloro(trichloromethyl)silane, and Trichloro(vinyl) silane.

18. The solution of claim 4, wherein the amino acid has the general formula H₂NCHRCOOH where R is an organic moiety.

19. The solution of claim 1, wherein the polyphenol is a phenolic acid.

20. The solution of claim 1, wherein the polyphenol is selected from the group consisting of tannic acid, gallic acid, castalagin, castalin, ellagic acid, curcumin, theaflavin, catechin, epicatechin, epigallocatechin, quercetin, kaempferol, galangin, fisetin, myricetin, cinnamic acid, p-coumaric acid, caffeic acid, ferulic acid, sinapic acid, gentisic acid, vanillic acid, gallic acid, syringic acid, protocatechuic acid, resveratrol, piceatannol, rhapontigenin, isorhapontigenin, pinosylvin, and pterostilbene.
